(19) United States
(12) Patent Application Publication
(10) Pub. No.: US 2010/0168895 A1
(43) Pub. Date: Jul. 1, 2010

(54) MASK VERIFICATION METHOD, METHOD OF MANUFACTURING SEMICONDUCTOR DEVICE, AND COMPUTER READABLE MEDIUM

(76) Inventors: Hiromitsu MASHITA, Yokohama-shi (JP); Fumiharu Nakajima, Yokohama-shi (JP); Toshiya Kotani, Machida-shi (JP); Hidefumi Mukai, Kawasaki-shi (JP); Issui Aiba, Yokkaichi-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/561,626

(22) Filed: Sep. 17, 2009

(30) Foreign Application Priority Data
Oct. 30, 2008 (JP) 2008-279663

(51) Int. Cl. G05B 13/04; G06F 17/50

(52) U.S. Cl. 700/103; 716/21; 716/19; 700/121

(57) ABSTRACT

A mask verification method includes setting optical parameters, verifying whether a pattern, which is obtained when a mask pattern other than a reference pattern of patterns on a mask is transferred on a substrate with use of the set optical parameters, satisfies dimensional specifications, and varying, when the pattern which is obtained when the mask pattern is transferred on the substrate is determined to fail to satisfy the dimensional specifications, the optical parameters at the time of transfer such that the pattern, which is obtained when the reference pattern is transferred on the substrate, satisfies a target dimensional condition, and verifying whether a pattern, which is obtained when the mask pattern other than the reference pattern of the patterns on the mask is transferred on the substrate with use of the varied optical parameters, satisfies the dimensional specifications.

### CROSS-REFERENCE TO RELATED APPLICATIONS

This application is based upon and claims the benefit of priority from prior Japanese Patent Application No. 2008-279663, filed Oct. 30, 2008, the entire contents of which are incorporated herein by reference.

### BACKGROUND OF THE INVENTION

1. Field of the Invention

The present invention relates to a mask verification method for verifying whether a photomask, which is formed, has a required precision or not, a method of manufacturing a semiconductor device in which a pattern is formed by using optical parameters which are verified by the mask verification method, and a computer readable medium which enables proper mask verification.

2. Description of the Related Art

With the development in microfabrication of semiconductor devices, the precision of a photomask causes a greater optical proximity effect (OPE) in an exposure result (see, e.g. Japanese Patent Application No. 2006-58452). Thus, there has been a greater demand for the precision of photomasks, and it has become difficult to fabricate photomasks with a stable yield.

In conventional mask verification, an exposure simulation is conducted on a mask pattern with use of fixed optical parameters, and verification is executed by comparing the dimensions of a pattern, which is obtained by the simulation, with the dimensions of a target pattern. The optical parameters are calculated so that a specific mask pattern may have dimensions corresponding to the dimensions of a desired transferred pattern on a resist.

However, in a case where a simulation is conducted, with use of the above-described optical parameters, on a mask pattern other than the specific mask pattern of the patterns that are formed on the mask, it is possible that the dimensions of a transferred pattern, which is obtained by the simulation, may greatly differ from target dimensions. The reason for this is that the optical parameters in the verification simulation are fixed in accordance with the specific pattern.

In the conventional mask verification, there has been a case in which a mask is determined to be defective when the dimensions of a pattern, which is transferred with use of specific optical parameters, greatly deviate from target dimensions.

### BRIEF SUMMARY OF THE INVENTION

According to a first aspect of the present invention, there is provided a mask verification method comprising: setting optical parameters at a time of transfer such that a pattern, which is obtained when a reference pattern that is selected from patterns on a mask is transferred on a substrate, satisfies a target dimensional condition; verifying whether a pattern, which is obtained when a mask pattern other than the reference pattern of the patterns on the mask is transferred on the substrate with use of the set optical parameters, satisfies dimensional specifications; and varying, when the pattern which is obtained when the mask pattern is transferred on the substrate is determined to fail to satisfy the dimensional specifications, the optical parameters at the time of transfer such that the pattern, which is obtained when the reference pattern is transferred on the substrate, satisfies the target dimensional condition, and verifying whether a pattern, which is obtained when the mask pattern other than the reference pattern of the patterns on the mask is transferred on the substrate with use of the varied optical parameters, satisfies the dimensional specifications.

According to a second aspect of the present invention, there is provided a method of manufacturing a semiconductor device, comprising: setting optical parameters at a time of transfer such that a pattern, which is obtained when a reference pattern that is selected from among patterns on a mask is transferred on a substrate, satisfies a target dimensional condition; verifying whether a pattern, which is obtained when a mask pattern other than the reference pattern of the patterns on the mask is transferred on the substrate with use of the set optical parameters, satisfies dimensional specifications; varying, when the pattern which is obtained when the mask pattern is transferred on the substrate is determined to fail to satisfy the dimensional specifications, the optical parameters at the time of transfer such that the pattern, which is obtained when the reference pattern is transferred on the substrate, satisfies the target dimensional condition, verifying whether a pattern, which is obtained when the mask pattern other than the reference pattern of the patterns on the mask is transferred on the substrate with use of the varied optical parameters, satisfies the dimensional specifications, and repeating the varying of the optical parameters until a verification result which satisfies the dimensional specifications is obtained; and transferring the pattern on the mask onto the substrate by using the optical parameters which satisfy the dimensional specifications.

According to a third aspect of the present invention, there is provided a computer readable medium configured to store program instructions, which causes a computer to execute: setting optical parameters which become an exposure condition at a time of transfer such that a pattern, which is obtained when a reference pattern that is selected from patterns on a mask is transferred on a substrate, satisfies a target dimensional condition; verifying whether a pattern, which is obtained when a mask pattern other than the reference pattern of the patterns on the mask is transferred on the substrate with use of the set optical parameters, satisfies dimensional specifications; and setting the optical parameters when the pattern which is obtained when the mask pattern is transferred is determined to satisfy the dimensional specifications, varying, when the pattern which is obtained when the mask pattern is transferred is determined to fail to satisfy the dimensional specifications, the optical parameters at the time of transfer such that the pattern, which is obtained when the reference pattern is transferred on the substrate, satisfies the target dimensional condition, verifying whether a pattern, which is obtained when the mask pattern other than the reference pattern of the patterns on the mask is transferred on the substrate with use of the varied optical parameters, satisfies the dimensional specifications, and repeating the varying of the optical parameters until a verification result which satisfies the dimensional specifications is obtained.

### BRIEF DESCRIPTION OF THE SEVERAL VIEWS OF THE DRAWING

FIG. 1 is a pattern plan view showing an example of layout in the vicinity of select gates in a cell region of a NAND flash memory;

FIG. 2 is a view for explaining the influence of mask mean value errors upon target pattern dimensions on a resist;

FIG. 3 is a flow chart for explaining a calculation method of optical parameters of an exposure device;

FIG. 4 is a flow chart for describing a modification of the calculation method of optical parameters of the exposure device;

FIG. 5 is a view for explaining the influence of mask mean value errors upon target pattern dimensions on a resist, after the optical parameters of the exposure device are adjusted;

FIG. 6 is a block diagram for describing a program of an exposure condition which enables proper mask verification, FIG. 6 schematically showing the structure of an apparatus which executes the program; and

FIG. 7 is a flow chart of an adjustment program, explaining the program of the exposure condition which enables proper mask verification.

### DETAILED DESCRIPTION OF THE INVENTION

An embodiment of the present invention will now be described with reference to the accompanying drawings.

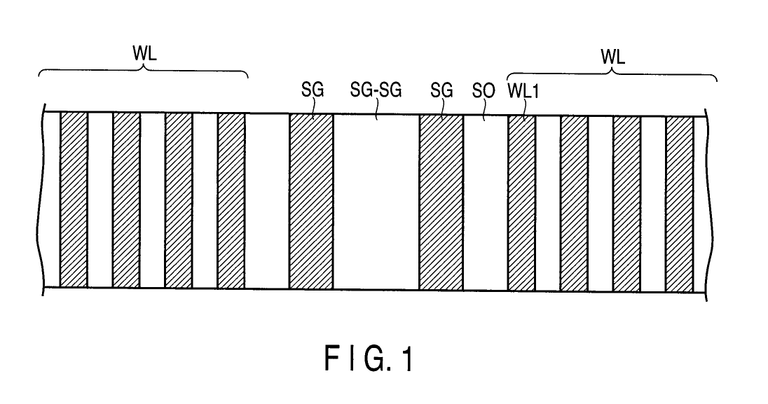

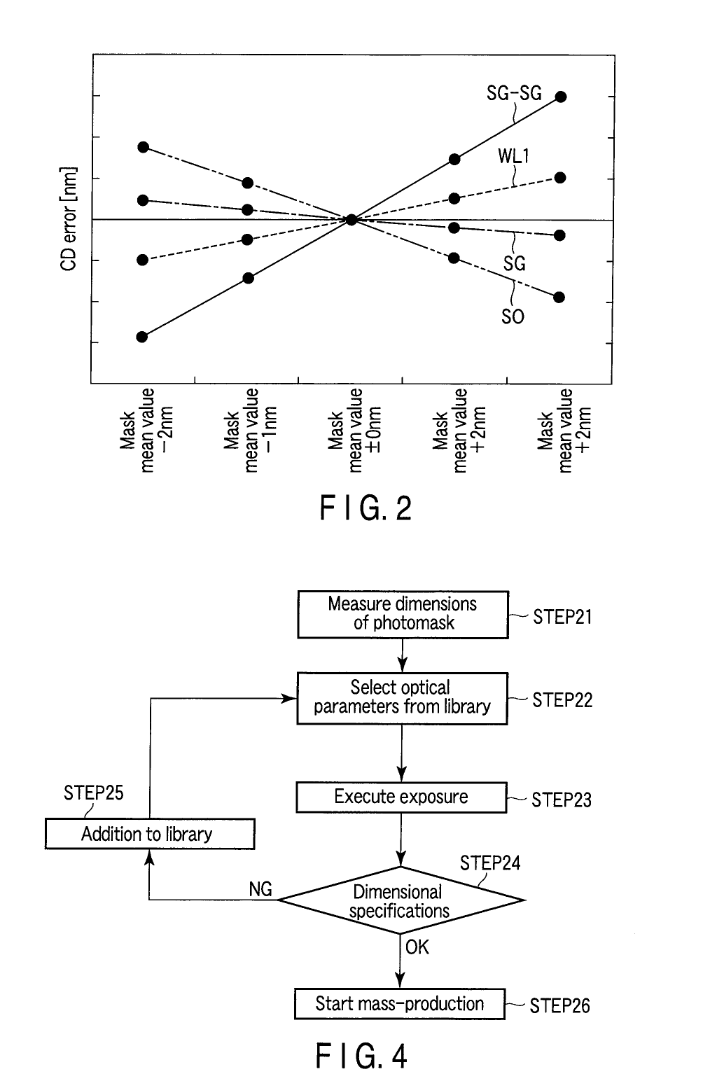

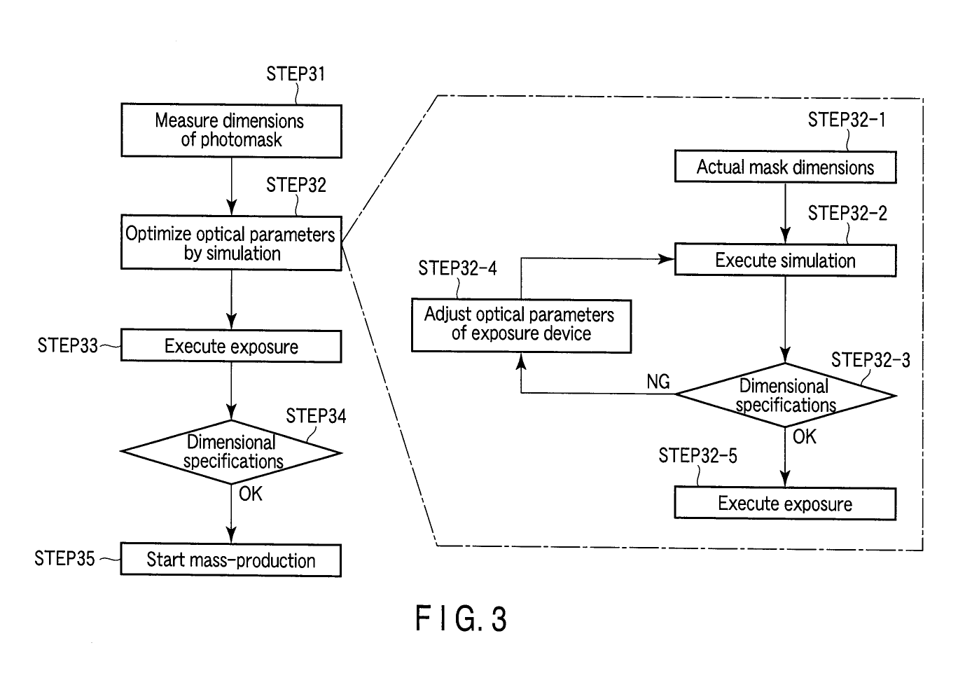

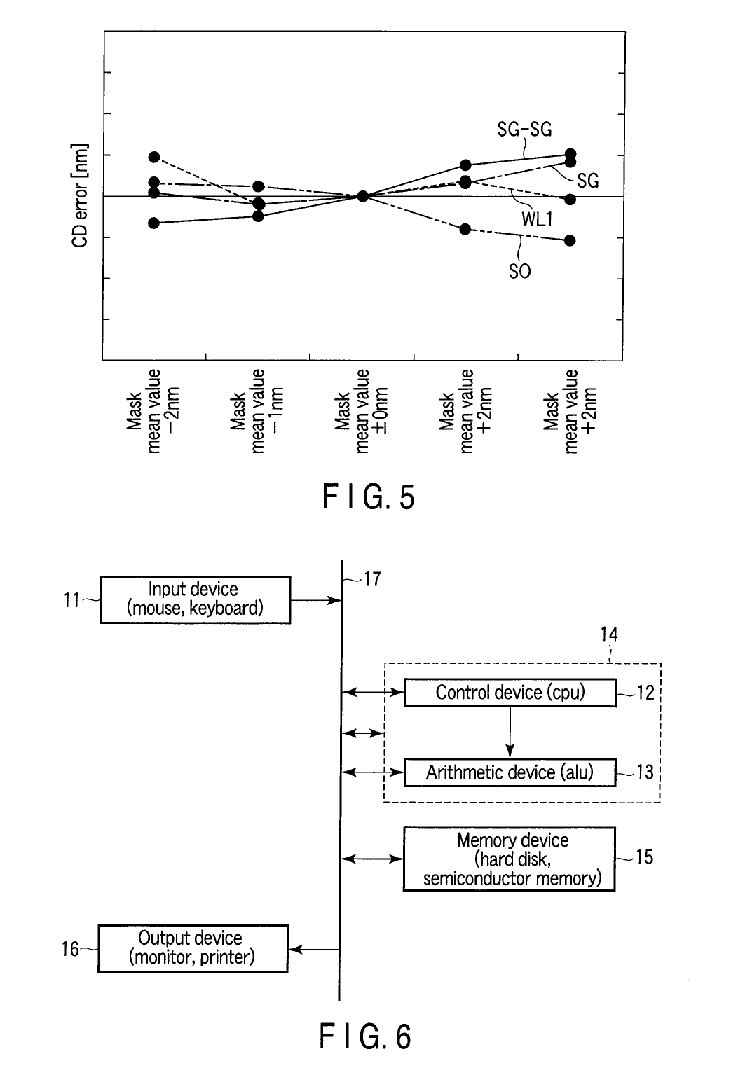

A mask verification method, a manufacturing method of a semiconductor device and an adjustment program of an exposure condition according to the embodiment of the invention are described with reference to FIG. 1 to FIG. 5. FIG. 1 is a pattern plan view showing an example of layout in the vicinity of select gates in a memory cell region of a NAND flash memory. FIG. 2 is a view for explaining the influence of mask mean value errors, that is, mean values of errors from design values (target values) of each mask pattern on a mask, upon resist dimensions. FIG. 3 is a flow chart for describing a calculation method of optical parameters of an exposure device. FIG. 4 is a flow chart for describing a modification of the calculation method of optical parameters of the exposure device. FIG. 5 is a view for explaining the influence of mask mean value errors upon resist dimensions, after the optical parameters of the exposure device are adjusted.

The present embodiment relates to a method of cancelling the influence of mask mean value errors by adjusting optical parameters. A description is given of a method of correcting an OPE, which is caused by dimension errors from design values (target dimension values) of a pattern on a photomask, by optical parameters of an exposure device. In the description below, a NAND flash memory is taken as an example of the semiconductor device.

As is shown in FIG. 1, the cycle of patterns in a memory cell region of a NAND flash memory is irregular in the vicinity of select gates SG (“non-cyclic pattern”). Thus, an OPE, which is caused by dimension errors from target dimension values of a photomask, becomes greater in the formation in the vicinity of select gates SG, in particular, in the formation of a space between select gates SG and a space between the select gate SG and a word line WL. On the other hand, an OPE, which is caused by dimension errors from target dimension values of a photomask, becomes relatively small in the formation of cyclically arranged word lines WL, in particular, in the formation of a word line WL which is disposed near the center between two select gates SG (depiction of one of the two select gates SG is omitted) which sandwich cyclically arranged word lines WL.

FIG. 2 shows the relationship between dimension errors from target dimension values of mask patterns for forming a region SG-SG between the select gates, the select gate SG, a region S0 between the select gate and the word line, and the word line WL1, on the one hand, and errors (CD (critical dimension) errors) from target pattern dimensions on the resist when the respective mask patterns are transferred on a substrate, on the other hand. In FIG. 2, the ordinate indicates the errors (CD errors) from target pattern dimensions on the resist when the respective mask patterns are transferred on the substrate, and the abscissa indicates the amounts of dimension errors from target dimension values of the mask patterns of the region SG-SG between the select gates, the select gate SG, the region S0 between the select gate and the word line, and the word line WL1. The increase/decrease amounts of mask mean values, which are plotted on the abscissa in FIG. 2, indicate that the respective mask patterns uniformly deviate from design values (target values) by these increase/decrease amounts.

In the case where a dimensional error from the target resist dimension adversely affects the device operation specifications, that is, in the case where the target dimensional condition fails to be satisfied, the exposure condition of the exposure device is set, for example, the optical parameters are adjusted, so as to obtain the resist dimensions which do not adversely affect the device operation. The optical parameters include, for instance, an illumination shape, a numerical aperture (NA), a degree of polarization, a pole balance, an exposure amount and a focus position. The OPE can be varied by varying the optical parameters, which affect the OPE of the exposure device, from predetermined set values.

FIG. 3 is a flow chart for explaining a calculation method of optical parameters of the exposure device. In this calculation method, optical parameters are found (obtained) by simulation. To start with, the dimensions of a photomask are measured (STEP 31), and the optical parameters are optimized by a simulation by using the measured dimension data of the photomask (STEP 32).

In the dimension measurement, mask reference actual dimensions, which are dimensions of a reference pattern on the photomask, and mask actual dimensions, which are dimensions of a mask pattern other than the reference pattern, are measured. As the reference pattern, a mask pattern corresponding to a line-and-space pattern (cyclic pattern), such as word lines of a NAND flash memory, is preferable, and a mask pattern corresponding to word lines near the center between select gates is more preferable.

In the above-mentioned simulation, the dimensions of the mask pattern are measured (STEP 32-1), a simulation is performed (STEP 32-2), and it is determined whether dimensional specifications are satisfied (STEP 32-3). In the simulation, a transfer simulation is performed in advance on the basis of the measured mask reference actual dimensions of a reference pattern, and optical parameters at the time of transfer are set such that a transferred pattern satisfies a target dimensional condition. Then, a transfer simulation is performed with optical parameters which are set on the basis of mask actual dimensions of a mask pattern other than the reference pattern (STEP 32-2). It is verified whether the transfer pattern, which is obtained by the simulation of the mask pattern other than the reference pattern, satisfies the dimensional specifications on the resist (STEP 32-3). In the case where the dimensional specifications are not satisfied, the optical parameters of the exposure device are varied so that the transfer pattern of the reference pattern may satisfy the target dimensional condition (STEP 32-4), and a transfer simulation is executed once again by using optical parameters which are varied on the basis of the mask actual dimensions of the mask pattern other than the reference pattern (STEP 32-2). Thereafter, the verification step (STEP 32-3) is executed and, when necessary, the optical parameter varying step (STEP 32-4) and simulation step (STEP 32-2) are repeated. On the other hand, if it is determined in the verification step (STEP 32-3) that the transfer pattern meets the dimensional specifications, the mask is determined as a non-defective mask and exposure is performed (STEP 32-5).

In this manner, the simulation is repeated while the optical parameters are varied, and the optical parameters are optimized so that all patterns on the resist may have dimensions which do not affect the device operation specifications. Thereby, non-defective/defective masks can properly be verified. In the meantime, instead of the simulation step (STEP 32-2), an experiment of transfer may actually be performed.

Subsequently, the obtained optimal parameters are set in the exposure device, and exposure is performed (STEP 33), and it is also confirmed by an experiment whether the dimensional specifications are satisfied (STEP 34). In STEP 34, dimensional measurement is conducted with respect to a pattern on the resist, which corresponds to the reference pattern that has been used for setting the exposure amount of the exposure device, a pattern on the resist, which has a great effect on device characteristics, and a pattern on the resist, which greatly suffers the effect of OPE and loses cyclicity, thereby confirming whether dimensional specifications are satisfied or not.

If it is confirmed that the dimensional specifications are satisfied, mass-production of semiconductor devices is started by using the obtained mask (STEP 35).

FIG. 4 shows a modification of the calculation method illustrated in FIG. 3. In this modification, optical parameters, with which dimensional errors from target resist dimension values, fall within tolerable ranges, are obtained by experiments in advance in association with the respective dimension values of a photomask, and the obtained optical parameters are stored in a database (library). Optimal optical parameters are selected from the database (library), on the basis of the measured photomask dimensions.

In this calculation method, to start with, the dimension measurement of the photomask is performed (STEP 21). In this dimension measurement, the mask reference actual dimensions of the reference pattern on the photomask are measured.

On the basis of the measurement result of the mask reference actual dimensions, the optical parameters are selected (set) from the library (STEP 22). Subsequently, using the selected optical parameters, exposure is conducted, by a simulation or by an experiment, on a mask pattern other than the reference pattern (STEP 23). Thereafter, it is verified whether desired device characteristics are satisfied by a transferred pattern. Specifically, it is determined whether the transferred pattern satisfies the dimensional specifications (e.g. error amounts from target values of dimensions) which are set from, e.g. device characteristics that are to be satisfied (STEP 24). If the dimensional specifications are not satisfied, the mask pattern other than the reference pattern, and optical parameters which are varied are added to the library (STEP 25). After the pattern of the photomask and the varied optical parameters are added to the library, the process returns to STEP 22. Thereafter, the added optical parameters are selected from the library, and exposure is conducted by a simulation or by an experiment with use of the added optical parameters (STEP 23). Then, it is verified once gain whether the desired device characteristics are satisfied by the transferred pattern. If it is determined in STEP 24 that the dimensional specifications are satisfied, the obtained mask is used to start mass-production of semiconductor devices (STEP 26). In the manufacturing process of the semiconductor device, the pattern of the photomask is transferred onto the semiconductor substrate, and various semiconductor elements and wirings are formed by using the transferred pattern.

FIG. 5 shows CD errors which are caused by dimensional errors from target values of the photomask of the region SG-SG between the select gates, the select gate SG, a region S0 between the select gate and the word line, and the word line WL1, when the optical parameters of the exposure device are adjusted in association with the respective dimension values of the photomask by using the optical parameters which are adjusted by the above-described method.

As is clear from the comparison between FIG. 2 and FIG. 5, the influence of the mask mean value errors upon the resist dimensions can be dispersed and effectively reduced by adjusting the optical parameters of the exposure device.

In the meantime, when the optical parameters (NA, σ, the degree of polarization, the amount of exposure, and focus position), which are used in the simulation, are optimized, if an increase in cost is taken into account, it becomes possible to set the mask dimensions within such a range of dimensional specifications that the cost does not affect the device characteristics. As regards the mask dimensions which are used in the simulation, it is better to set the dimension values of the other pattern in consideration of the PPE (pattern placement error) of mask fabrication, on the basis of the dimensions of the reference pattern for setting the exposure amount of the exposure device. Furthermore, the slice level, which is set in the simulation, can be calculated on the basis of the light intensity distribution of the reference pattern for setting the exposure amount of the exposure device. For example, since a resist pattern which corresponds to the reference pattern becomes a line-and-space pattern corresponding to a region with a low light intensity and a region with a high intensity of the reference pattern, the light intensity, at which the width of the region with low light intensity agrees with the line width of the reference pattern, is set at the slice level.

The effect of mask mean value errors can be canceled by setting the calculated optical parameters in the exposure device and fabricating the photomask by exposure.

As has been described above, the present embodiment can provide a mask verification method which can perform proper verification corresponding to a mask pattern. In addition, since a product, which has been treated as a defective product in the prior art, can be used as a non-defective product, the manufacturing yield of the semiconductor device can be improved. Moreover, by causing a computer to execute the above-described optical parameter optimizing procedure shown in FIG. 3, it is possible to provide a program of an exposure condition which enables proper mask verification.

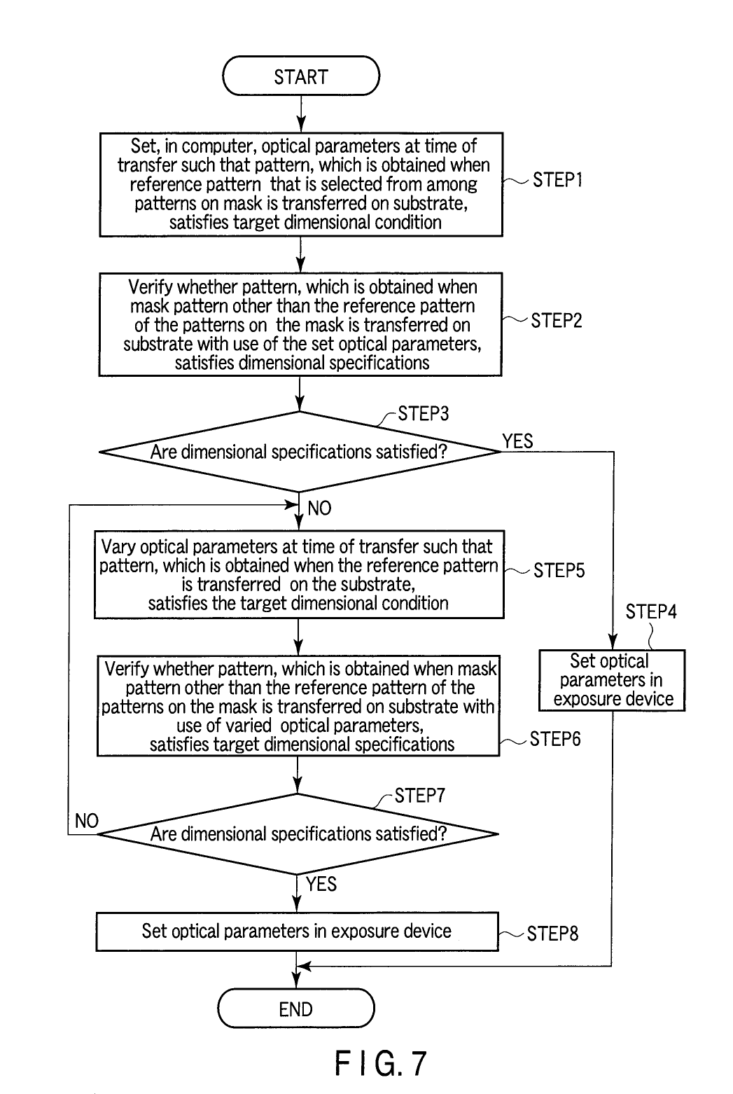

FIG. 6 and FIG. 7 are views for explaining the program of the exposure condition which can perform proper mask verification. FIG. 6 is a block diagram which schematically shows the structure of an apparatus which executes the program, and FIG. 7 is a flow chart of an adjustment program of the exposure condition. FIG. 6 shows, by way of example, the case of using a personal computer. The personal computer includes an input device 1 such as a keyboard or a mouse, a processing device 14 including a control device (CPU) 12 and an arithmetic device (ALU) 13, a memory device 15 such as a hard disk or a semiconductor memory, and an output device 16 such as a monitor or a printer. These devices are commonly connected via a signal transmission path such as a bus line 17, and data and control signals are transmitted/received between these devices.

The control device 12 and arithmetic device 13 constitute the processing device 14 which execute various processes. The control device 12 controls the operations of the input device 11, arithmetic device 13, memory device 15 and output device 16. The memory device 15 stores, in addition to the verification program, a program in which instructions for controlling the respective devices by the control device 12 are described. In accordance with the control by this program, the exposure condition of the exposure device is calculated by the arithmetic device 13, and is adjusted.

Specifically, from the input device 11 such as a keyboard or a mouse, optical parameters, which become the exposure condition at the time of transfer, are input so that a pattern, which is obtained when a reference pattern selected from among the patterns on the mask is transferred, may satisfy a target dimensional condition. The input optical parameters are transferred and stored in the memory device 15 via the bus line 17 on the basis of the control of the processing device 14 (STEP 1). The optical parameters include at least one of an illumination shape, a numerical aperture, a degree of polarization, a pole balance, an exposure amount and a focus position, which are used when a pattern on the mask is transferred onto the substrate.

Subsequently, it is verified whether a pattern, which is obtained when a mask pattern other than the reference pattern of the patterns on the mask is transferred on the substrate with use of the optical parameters that are stored in the memory device 14, satisfies dimensional specifications (STEP 2). This verification is performed by executing an exposure simulation on the mask pattern by the arithmetic device 13 by using the optical parameters stored in the memory device 14, and comparing the pattern, which is obtained by the simulation, with a target pattern.

It is determined by the arithmetic device 13 whether the dimensional specifications are satisfied or not (STEP 3). If it is determined that the dimensional specifications are satisfied, the optical parameters are set in the exposure device (STEP 4). On the other hand, if it is determined that the dimensional specifications are not satisfied, the optical parameters at the time of transfer are varied so that the pattern, which is obtained when the reference pattern is transferred on the substrate, may satisfy the target dimensional condition (STEP 5), and it is verified by the arithmetic device 13 whether a pattern, which is obtained when the mask pattern other than the reference pattern of the patterns on the mask is transferred on the substrate with use of the varied optical parameters, satisfies the dimensional specifications (STEP 6). The varying of the optical parameters is repeated until a verification result that meets the dimensional specifications is obtained (STEP 7).

If the dimensional specifications are satisfied, the optical parameters are stored in the memory device 15 and are set in the exposure device (STEP 8). This verification result is output from the output device 16 such as a monitor or a printer.

In the above-described embodiment, it is verified whether the dimensions of the pattern (optical image intensity distribution), which is transferred on the resist, satisfies the target dimensional condition or dimensional specifications. Alternatively, the dimensions of a processed film pattern, which is obtained by processing a to-be-processed film by using this resist pattern as a mask, may be compared with a target dimensional condition or dimensional specifications, and may be verified. In this case, the above-described exposure simulation or exposure experiment in FIG. 3 (STEP 32-2) should preferably be replaced with a simulation or an experiment, which includes a pattern exposure step on the resist, a resist development step and a step of processing a to-be-processed film with use of the resist mask. Alternatively, a pattern conversion error due to processing should preferably be found (obtained) in advance, and the conversion error should be reflected on the target dimensional condition or dimensional specifications of the resist pattern.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A mask verification method comprising:
setting optical parameters at a time of transfer such that a pattern, which is obtained when a reference pattern that is selected from patterns on a mask is transferred on a substrate, satisfies a target dimensional condition;
verifying whether a pattern, which is obtained when a mask pattern other than the reference pattern of the patterns on the mask is transferred on the substrate with use of the set optical parameters, satisfies dimensional specifications; and
varying, when the pattern which is obtained when the mask pattern is transferred on the substrate is determined to fail to satisfy the dimensional specifications, the optical parameters at the time of transfer such that the pattern, which is obtained when the reference pattern is transferred on the substrate, satisfies the target dimensional condition, and verifying whether a pattern, which is obtained when the mask pattern other than the reference pattern of the patterns on the mask is transferred on the substrate with use of the varied optical parameters, satisfies the dimensional specifications.

2. The method according to claim 1, wherein the optical parameters include at least one of an illumination shape, a numerical aperture, a degree of polarization, a pole balance, an exposure amount and a focus position of an exposure device which is used when a pattern on the mask is transferred on the substrate.

3. The method according to claim 1, wherein of the patterns on the mask, the reference pattern is a cyclic pattern, and the pattern which satisfies the dimensional specifications is a non-cyclic pattern.

4. The method according to claim 1, wherein the optical parameters affect an optical proximity effect.

5. The method according to claim 1, wherein an optical proximity effect is varied by varying the optical parameters.

6. The method according to claim 1, wherein the optical parameters are obtained by a simulation.

7. The method according to claim 1, wherein the optical parameters are obtained by an experiment.

8. A method of manufacturing a semiconductor device, comprising:
setting optical parameters at a time of transfer such that a pattern, which is obtained when a reference pattern that is selected from among patterns on a mask is transferred on a substrate, satisfies a target dimensional condition;
verifying whether a pattern, which is obtained when a mask pattern other than the reference pattern of the patterns on the mask is transferred on the substrate with use of the set optical parameters, satisfies dimensional specifications;
varying, when the pattern which is obtained when the mask pattern is transferred on the substrate is determined to fail to satisfy the dimensional specifications, the optical parameters at the time of transfer such that the pattern, which is obtained when the reference pattern is transferred on the substrate, satisfies the target dimensional condition, verifying whether a pattern, which is obtained when the mask pattern other than the reference pattern of the patterns on the mask is transferred on the substrate with use of the varied optical parameters, satisfies the dimensional specifications, and repeating the varying of the optical parameters until a verification result which satisfies the dimensional specifications is obtained; and
transferring the pattern on the mask onto the substrate by using the optical parameters which satisfy the dimensional specifications.

9. The method according to claim 8, wherein the optical parameters include at least one of an illumination shape, a numerical aperture, a degree of polarization, a pole balance, an exposure amount and a focus position of an exposure device which is used when the pattern on the mask is transferred on the substrate.

10. The method according to claim 8, wherein of the patterns on the mask, the reference pattern is a cyclic pattern, and the pattern which satisfies the dimensional specifications is a non-cyclic pattern.

11. The method according to claim 8, wherein the optical parameters affect an optical proximity effect.

12. The method according to claim 8, wherein an optical proximity effect is varied by varying the optical parameters.

13. The method according to claim 8, wherein the optical parameters are obtained by a simulation.

14. The method according to claim 8, wherein the optical parameters are obtained by an experiment.

15. A computer readable medium configured to store program instructions, which causes a computer to execute:
setting optical parameters which become an exposure condition at a time of transfer such that a pattern, which is obtained when a reference pattern that is selected from patterns on a mask is transferred on a substrate, satisfies a target dimensional condition;
verifying whether a pattern, which is obtained when a mask pattern other than the reference pattern of the patterns on the mask is transferred on the substrate with use of the set optical parameters, satisfies dimensional specifications; and
setting the optical parameters when the pattern which is obtained when the mask pattern is transferred is determined to satisfy the dimensional specifications, varying, when the pattern which is obtained when the mask pattern is transferred is determined to fail to satisfy the dimensional specifications, the optical parameters at the time of transfer such that the pattern, which is obtained when the reference pattern is transferred on the substrate, satisfies the target dimensional condition, verifying whether a pattern, which is obtained when the mask pattern other than the reference pattern of the patterns on the mask is transferred on the substrate with use of the varied optical parameters, satisfies the dimensional specifications, and repeating the varying of the optical parameters until a verification result which satisfies the dimensional specifications is obtained.
